(19) United States
(12) Patent Application Publication
(10) Pub. No.: US 2009/0154147 A1
(43) Pub. Date: Jun. 18, 2009

(54) Foldable container

(76) Inventor: Wing Choi, Pasadena, CA (US)

Correspondence Address: Cislo & Thomas LLP, 1333 2nd Street, Suite #500, Santa Monica, CA, 90401-4110, US

(21) Appl. No.: 12/002,219

(22) Filed: Dec. 14, 2007

(51) Int. Cl. B65D 37/00; B65D 51/00; B65D 25/00; B65D 25/28; F21V 33/00

(52) U.S. Cl. 362/154; 220/9.2

(57) ABSTRACT

The present invention relates to containers, and in particular a foldable container having a flat, stable base with two expandable side walls that extend up from the base and meet together to close the container. When the expandable side walls are in their folded, down position, the container is in an open position and is capable of receiving an object. When the side walls are expanded and secured together, the container can close around an object. The container is useful for carrying and containing objects, including food items such as truffles, cakes, hard candy or other deserts, take-out meals, and party snacks; cosmetics, party favors, wedding favors, and gift items such as jewelry, clothing, trinkets, toys, accessories; miscellaneous prizes; or informational matter such as gift cards, vouchers, coupons, or event tickets; and providing light for the object or an environment.

### TECHNICAL FIELD

This invention relates to foldable containers for carrying, storing, or holding various items.

### BACKGROUND ART

Gift wrapping items and carrying, storing, or holding items in a useful, functional, and beautiful device can be time consuming and difficult. Gift wrapping can require cutting and sizing paper for awkwardly shaped items, scissors, tape, and ribbon. Additionally, holding and carrying items in a useful, functional, and aesthetically pleasing device presents a challenge, as boxes can be plain, ordinary, and ugly, lack handles or an efficient way to close.

There is a need in the art for a container that can carry, store, or hold various items of different shapes and sizes in a useful, functional, and attractive way.

### DISCLOSURE OF INVENTION

The present invention comprises a foldable container having a flat, stable base with a top and a bottom, and a perimeter outlining the outside of the top and the bottom, two expandable side walls each of the same size, and each having a first edge and a second edge, the first edges and the second edges each having the same shape and size as one-half of the perimeter of the base, the first edge of each expandable side wall attached to one-half of the perimeter of the base, the second edge of each expandable side wall attached to a frame having the same size and shape as one-half of the perimeter of the base, one or more closure means on each of the second edges of the two expandable side walls, wherein the closure means secure the second edges of the two expandable side walls together and close the container, and one or more attachment means on the top of the base, wherein the attachment means secure the object to the top of the base. The foldable container may further comprise handles to carry and stabilize the container. The one or more attachment means on the top side of the base serve to affix an object on the base so that the object does not move around in the container when the container is moved from place to place.

The expandable side walls may contain a plurality of accordion pleats, may be bellows-like, may be made of telescoping folds, or may be configured such that expansion is available to the side walls. The side walls may be expanded ninety degrees (90°) so that when they are lifted, the second edges of the side walls meet at ninety degrees (90°) from the flat, stable base.

The perimeter of the flat base may have a substantially asymmetrical geometric shape; for example, a substantially square, circular, rectangular, oval, heart, diamond, hexagonal, parallelogram, or irregular symmetrical shape, and combinations thereof.

The attachment means may include one or more adhesive strips; malleable tabs made of metal, paper, plastic, or a combination thereof; hook and loop fasteners; and string, such as fabric or elastic string. The attachment means may be secured to the top of the base or anchored in the base.

The closure means affixed to each of the two expandable sides may include one or more magnets; pieces of hook and loop fasteners; malleable tabs made of metal, paper, plastic, or a combination thereof; friction fit pieces; and pieces that are shaped to fit within one another to form a secure hold. Friction fit pieces are meant to fit together and hold the two expandable sides securely shut. For example, a first friction fit piece on a first expandable side wall fits into a second friction fit piece on a second expandable side wall; thereby holding the foldable container in a closed position. The closure means hold the second edges of the two expandable side walls flush together at ninety degrees from the base or in a perpendicular orientation to the base.

One or more lights may also be included with the container. The light may be attached to the top of the base, attached to the frame, attached to the perimeter of the base inside of the container, attached to the perimeter of the base outside of the container, attached in and throughout the expandable side walls. For example, the lights may be lined the in one or more pleats in the expandable side walls. Alternatively, a user may place a light in the container. The lights may be battery powered, electric, wind-up, or other powered lights such as LED lights, low-voltage lights, and candles. The lights can be useful to use the containers to light a pathway, light a food or gift item in a dark venue, or assist in leading the way to a festive event where guests arrive carrying the containers with festive objects therein.

The stable base may be made of any kind of material such as cardboard, paper, bamboo, plastic, metal, and combinations thereof. The thickness of the material of the base is substantially thicker and sturdier than the material of the two expandable side walls to impart stability to the container. The expandable side walls may be made of paper such as food-grade paper or wax paper, origami paper, tissue paper, mesh paper, thin paper, foldable paper, gauze, and combinations thereof; or they may be made of plastic, cloth, or fabric; and they may be further embellished with a design. The expandable sides may contain accordion pleats, telescoping folds, or may be folded or constructed in a way such that they can be expanded in accordance with the present invention.

The frame in each of the two expandable side walls that is attached to the second edge of each of the expandable side walls may be made of bamboo, wire, or plastic.

Handles on the container may be the same as the attachment means or may be separate. If they are separate, they may be made of string, ribbon, metal, plastic, elastic, or paper. The handles may be removeably attached to the base and extending outside of the two expandable side walls, removeably attached to the base and extending through the two expandable side walls, attached to the expandable sides, and combinations thereof. In a preferred embodiment, the base of the container has one or more holes or openings to receive one or more strings or ribbons.

The ends of the one or more strings or ribbons may be shaped such that they maintain a cylindrical shape to fit through the one or more holes or openings in the base and then can be bent, tied, or expanded to secure the string or ribbon to the base. For example, the ends of the one or more strings may have a plastic cylindrical shell partially attached that maintains a cylindrical shape to fit through the one or more holes or openings, and then can be bent to form a t-shape to anchor the string or ribbon in place. In another embodiment, the ends of the one or more strings may have a malleable t-shape that can be bent to fit through the one or more holes or openings and anchor the string or ribbon in place.

Handles that are removeably attached to the base and extending outside of the two expandable side walls and/or removeably attached to the base and extending through the two expandable side walls assist in stabilizing the container, ensure that the object is sufficiently stable within the container, and prevent unstable, wobbly, or unpredictable movement of the expandable side walls relative to the base. Accordingly, the stable base along with the handles that are removeably attached to the base and extending outside of the two expandable side walls and/or removeably attached to the base and extending through the two expandable side walls assist in stabilizing the container and prevent unwanted expansion or compression of the two expandable side walls when the container is in use.

The one or more handles attached to the expandable side walls may be metal and may be shaped large enough for an individual to carry the container; for example, large enough to fit one or more fingers through the handle.

Methods of using the container are also contemplated, wherein the method comprises inserting one or more strings or ribbons into the one or more holes in the base, placing an object in the foldable container, securing it to the base with one or more attachment means, lifting the two expandable side walls ninety degrees (90°) to meet together, securing the two expandable side walls together, and tying the one or more strings or ribbons around the two expandable side walls.

### BRIEF DESCRIPTION OF DRAWINGS

FIG. 1 is a perspective view of one embodiment of the foldable container in its closed position where the flat, stable base has a substantially square shape.

FIG. 2 is an open top view of one embodiment of the foldable container where the flat, stable base has a substantially square shape and the two expandable side walls are in the down position.

FIG. 3 is a bottom view of one embodiment of the foldable container in its closed position where the flat, stable base has a substantially square shape.

FIG. 4 is a side view of one embodiment of the foldable container where the flat, stable base has a substantially square shape and the two expandable side walls are in a substantially down position.

FIG. 5 is a side view of one embodiment of the foldable container where the flat, stable base has a substantially square shape and the two expandable side walls are in the up position and secured together by a closure means.

FIG. 6 is a closed top view of one embodiment of the foldable container where the flat, stable base has a substantially square shape and the two expandable side walls are in the up position and secured together by a closure means.

FIG. 7 is a perspective view of one embodiment of the foldable container in its closed position where the flat, stable base has a substantially round shape.

FIG. 8 is a perspective view of one embodiment of the foldable container in its closed position where the flat, stable has the shape of a parallelogram.

FIG. 9 is a top view of one embodiment of the foldable container in its open position where the flat, stable base has the shape of a parallelogram.

FIG. 10 is a top view of one embodiment of the foldable container in its closed position where the flat, stable base is substantially heart-shaped.

FIG. 11 is a bottom view of one embodiment of the foldable container in its closed position where the flat, stable base is substantially heart-shaped.

FIG. 12 is a perspective view of one embodiment of the foldable container in its closed position where the flat, stable base has a substantially oval shape.

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The container is useful for holding objects, including food items such as truffles, cakes, hard candy or other deserts, take-out meals, and party snacks; battery powered, electric, or other powered lights such as LED lights, low-voltage lights, and candles; party favors, wedding favors, and gift items such as jewelry, clothing, trinkets, toys, accessories; miscellaneous prizes; or informational matter such as gift cards, vouchers, coupons, or event tickets.

The container is also useful for lighting objects contained within the container, adding mood lighting to outdoor and indoor pathways and areas, providing light for other gifts or objects in the vicinity of the container. The containers may be useful for hanging on hooks, walls, and/or posts for adding additional light to an indoor or outdoor area.

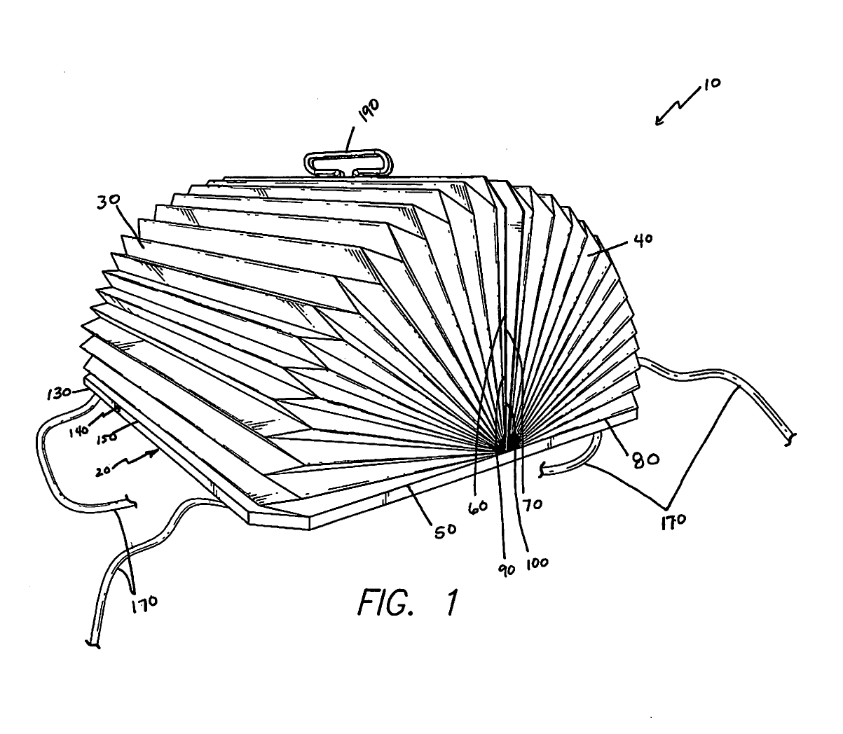

FIG. 1 shows a perspective view of one embodiment of the foldable container 10 of the present invention having a flat, stable base 20 with a top 140 and a bottom 130 with the edge perimeter 150 of the top 140 partially showing. The foldable container 10 has two expandable side walls 30 and 40, each of the same size, and each having a first edge 50 and 80 and a second edge 60 and 70, the first edges 50 and 80 and the second edges 60 and 70 each having the same size and shape as one-half of the perimeter 150 of the base 20. The first edges 50 and 80 are attached to one-half of the perimeter 150 on the top 140 of the base 20. The second edges 60 and 70 of each expandable side wall 30 and 40 are attached to a frame 90 and 100, respectively having the same size and shape as one-half of the perimeter 150 of the base 20. Also shown are one or more attachment means in the form of four strings attached to the base 160. The strings assist in securing an object within the container. One or more handles 190 are also shown.

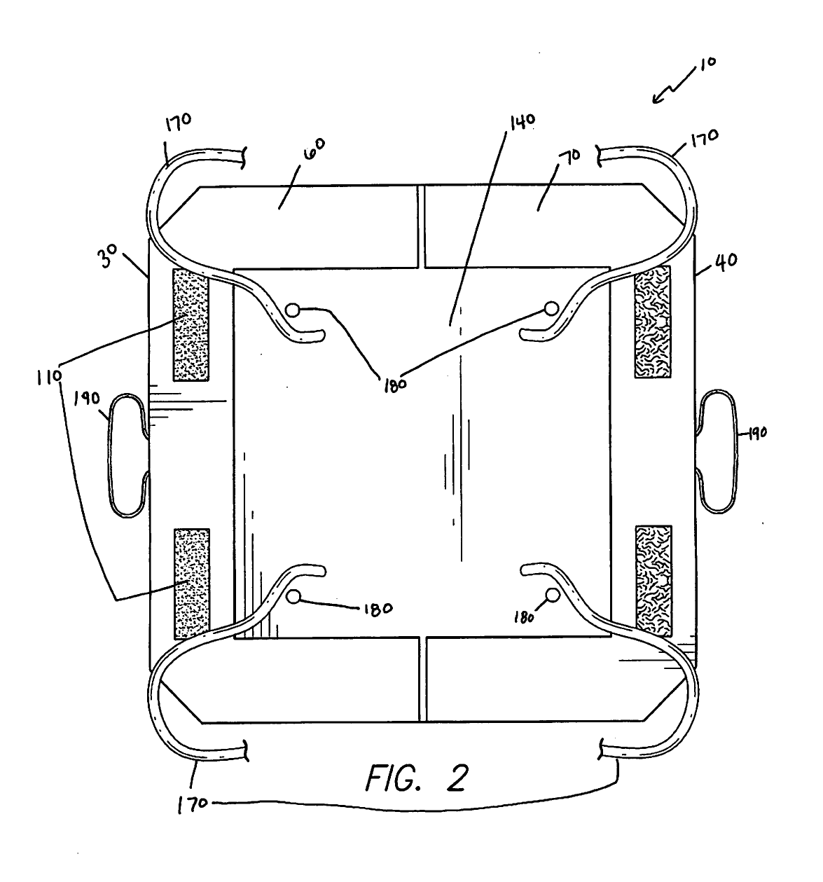

FIG. 2 depicts an open top view of one embodiment of the foldable container 10 of the present invention where the flat stable base 20 has a substantially square shape and the two expandable side walls 30 and 40 are in a substantially down position. One or more closure means 110 are shown on each of the second edges 60 and 70 of the two expandable side walls 30 and 40. The one or more closure means 110 serve to secure the second edges 60 and 70 of the two expandable side walls 30 and 40 together. One or more attachment means are also shown 170 attached to the top of the base 140 inside the area defined by the two expandable side walls 30 and 40. The attachment means 170 are four strings. Also shown are one or more holes in the base 180 capable of receiving one or more strings or ribbons that may be anchored through the base and may extend outside of the expandable side walls and then may be tied together to secure and stabilize the container. One or more handles are also shown 190.

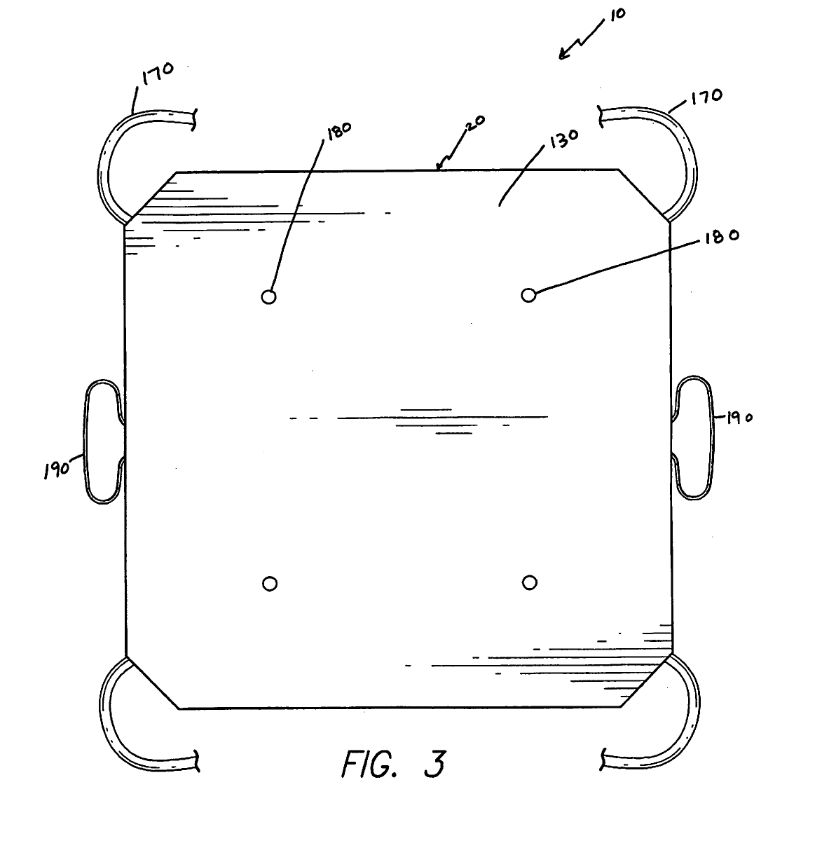

FIG. 3 shows a bottom view of one embodiment of the foldable container 10 where the flat, stable base 20 has a substantially square shape. The bottom 130 of the base 20 is shown. Also shown are one or more holes in the base 180 capable of receiving one or more strings or ribbons that may be anchored through the base and may extend outside of the expandable side walls and then may be tied together to secure and stabilize the container, one or more attachment means 170, and one or more handles 190.

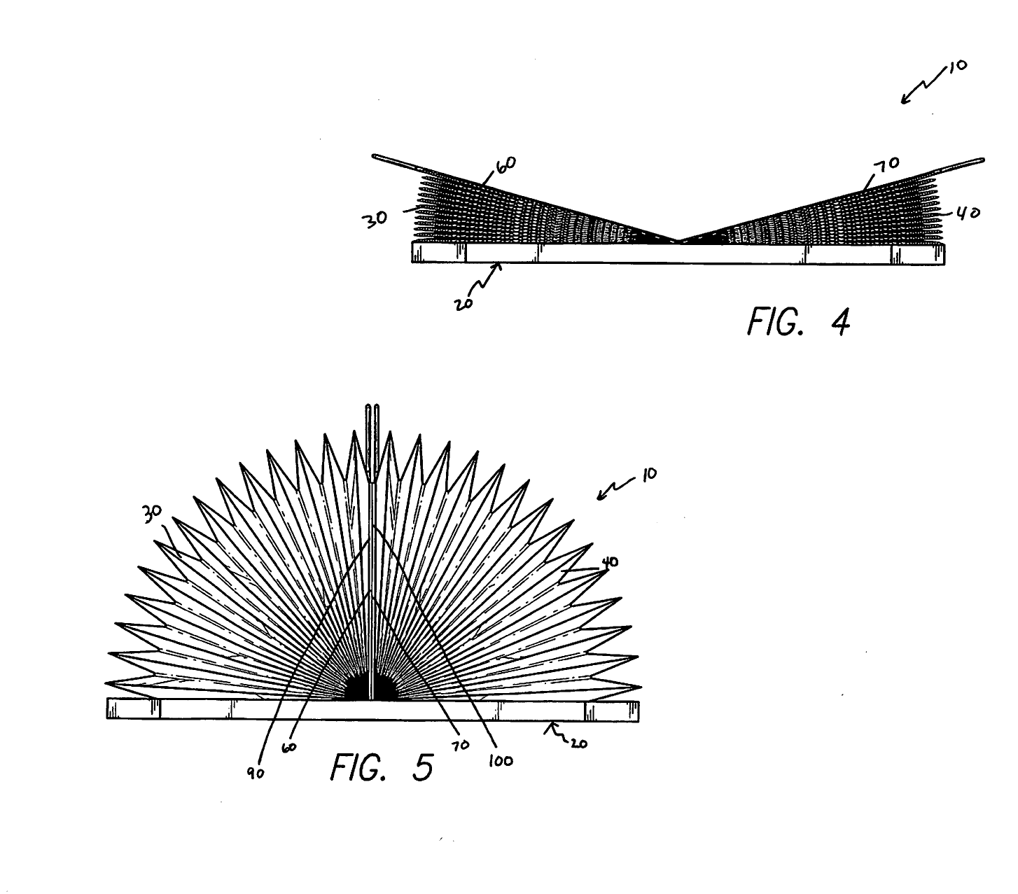

FIG. 4 is a side view of one embodiment of the foldable container 10 where the flat, stable base 20 has a substantially square shape, and the two expandable side walls 30 and 40 are in a substantially down position.

FIG. 5 shows a side view of one embodiment of the foldable container 10 where the flat, stable base 20 has a substantially square shape, and the two expandable side walls 30 and 40 are in the up position and secured together by closure means. The frames 90 and 100 within the second edges 60 and 70 of the two expandable side walls 30 and 40, respectively, are flush with one another when the expandable side walls 30 and 40 of the foldable container 10 are in the up position and are secured together by one or more closure means. The one or more closure means may be attached to the second edges 60 and 70.

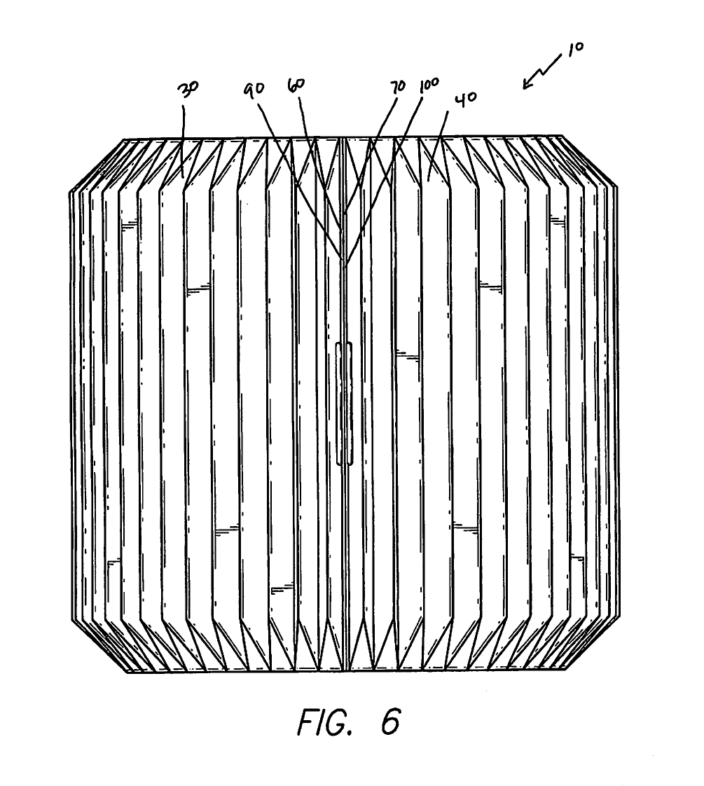

FIG. 6 shows a closed top view of one embodiment of one embodiment of the foldable container 10 where the flat, stable base has a substantially square shape and the two expandable side walls 30 and 40 are in the up position and secured together by a closure means. The frames 90 and 100 within the second edges 60 and 70 of the two expandable side walls 30 and 40, respectively, are flush with one another when the expandable side walls 30 and 40 of the foldable container 10 are in the up position.

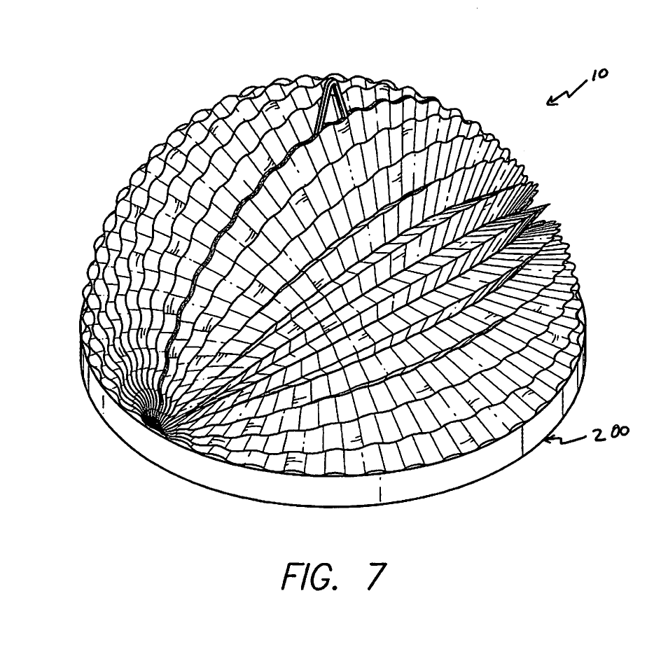

FIG. 7 is a perspective view of one embodiment of the foldable container 10 in its closed position where the flat, stable base 200 has a substantially round shape.

FIG. 8 is a perspective side view of one embodiment of the foldable container 10 in its closed position where the flat, stable base 300 has a substantially diamond shape.

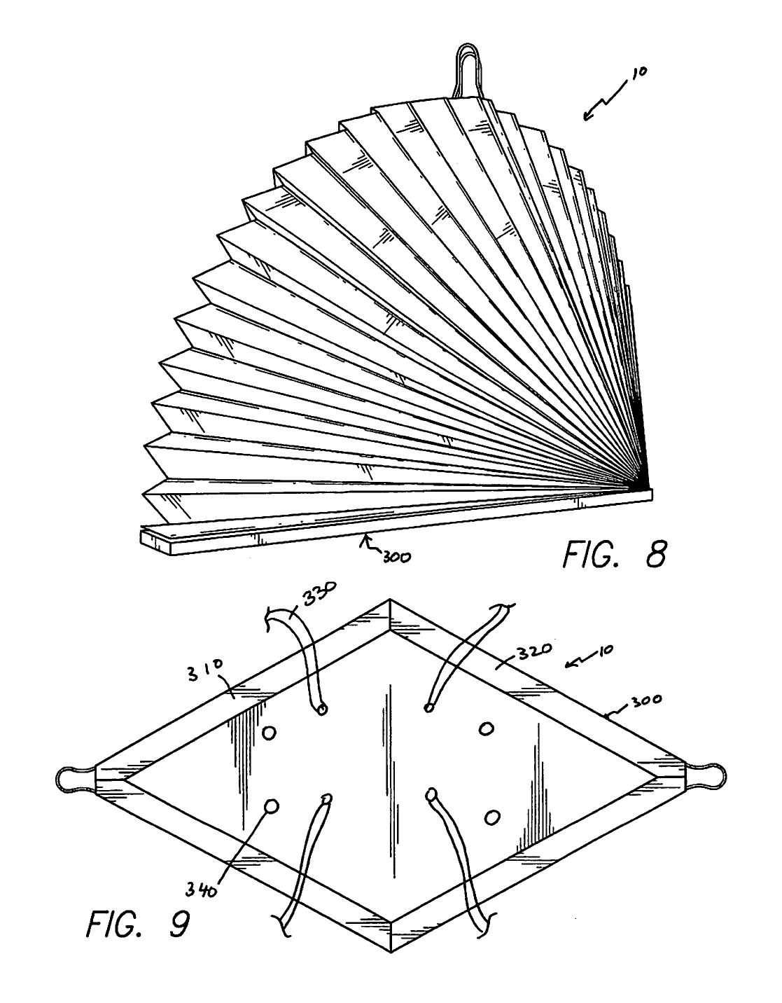

FIG. 9 is a top view of one embodiment of the foldable container 10 as shown in FIG. 8, in its open position where the flat, stable base 300 has a substantially diamond shape. The two expandable side walls 310 and 320 are shown in the down position. An attachment means may be positioned on the top of the base 330 that is within the boundary defined by the two expandable side walls 310 and 320. The attachment means 330 are shown as strings but may also be a number of mechanisms to secure objects such as adhesive strips, hook and loop fasteners, friction fit parts, pliable metal, and combinations thereof. Also shown are one or more holes in the base 340. One or more closure means may be attached to the expandable side walls 310 and 320 to secure the side walls together and close the foldable container 10.

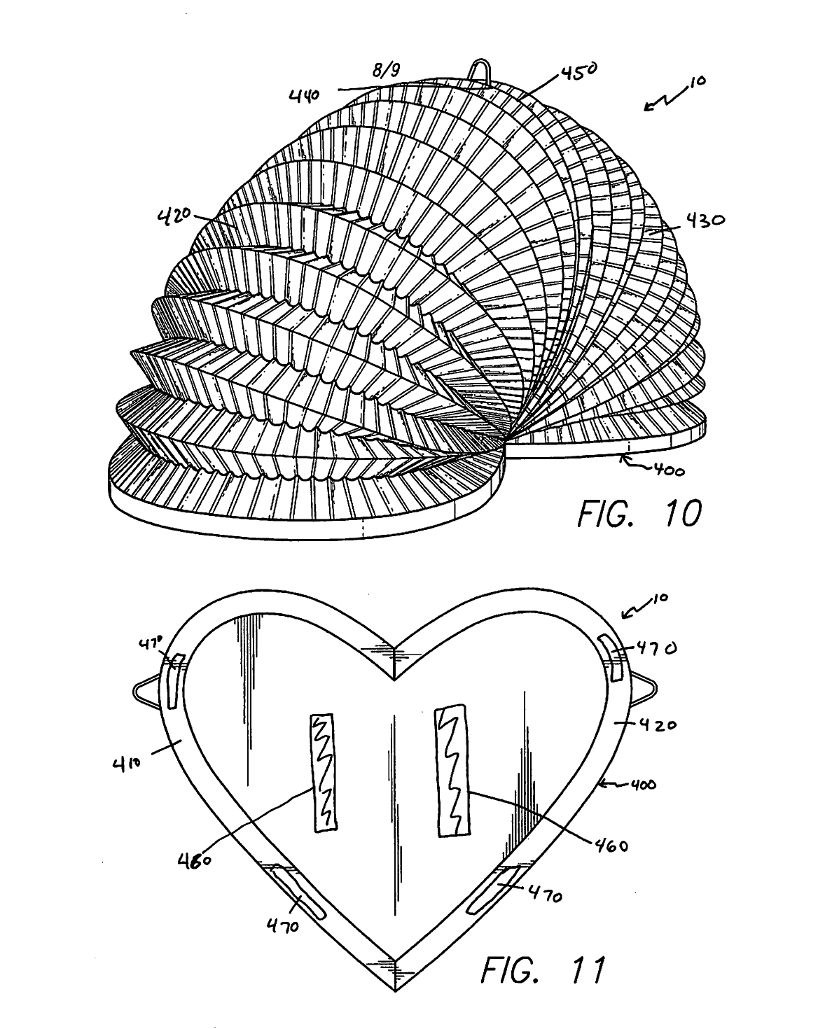

FIG. 10 is a perspective view of one embodiment of the foldable container 10 in its closed position where the flat, stable base 400 has a substantially heart shape with two expandable side walls 420 and 430 in the up position and the second edges 440 and 450 of each expandable side walls 420 and 430 are flush with one another.

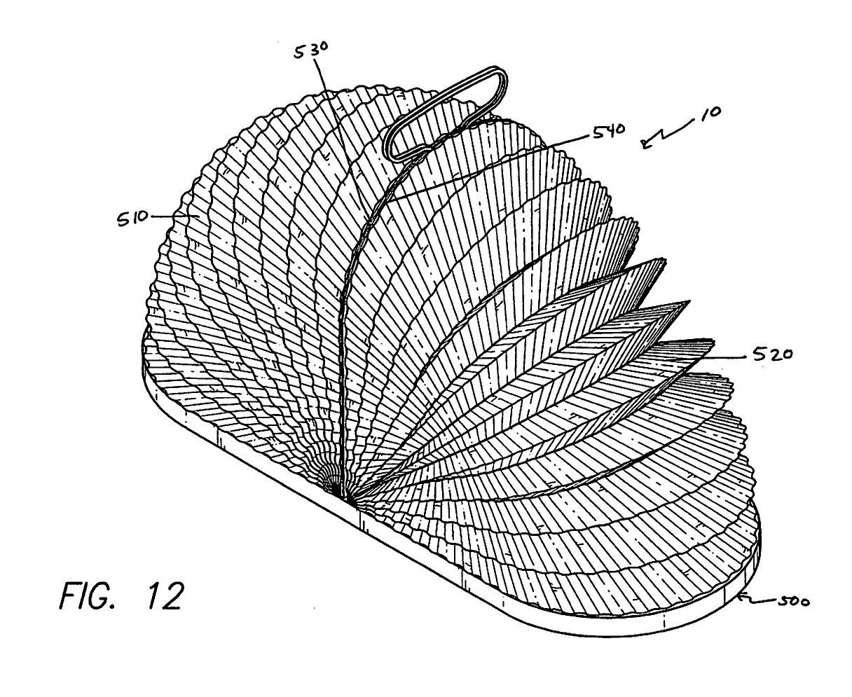

FIG. 11 is a top view of one embodiment of the foldable container 10, as shown in FIG. 10, in its open position where the flat, stable base 400 has a substantially diamond shape. The two expandable side walls 410 and 420 are shown in the down position. An attachment means 460 may be positioned on the top of the base within the boundary defined by the two expandable side walls 410 and 420. The one or more attachment means 460 are shown as adhesive strips. One or more closure means 470 may be attached to the expandable side walls 410 and 420 to secure the side walls together and close the foldable container 10. The closure means 470 shown are one or more magnets that are attached to the edges of the expandable side walls 410 and 420.

FIG. 12 is a perspective view of one embodiment of the foldable container 10 in its closed position where the flat, stable base, 500 has a substantially oval shape with two expandable side walls 510 and 520 in the up position and the second edges 530 and 540 of each expandable side walls 510 and 520 are flush with one another. One or more closure means may be externally attached to each of the second edges 530 and 540 to assist in securing the two expandable side walls 510 and 520 together.

The base of each of the aforementioned embodiments may be made of a material having a thickness that is substantially wider than the thickness of the two expandable side walls. The base is of a shape and a size to impart stability to the container. The base may have one or more holes to receive one or more strings or ribbons to serve as handles and to further stabilize the container.

In one embodiment, the two expandable side walls are paper, plastic, cloth, fabric, or combinations thereof. The paper may be food-grade paper or wax paper; origami-like paper with ornamentation thereon; thin tissue paper; opaque paper, gauzy paper, or thick, shiny paper. The plastic may be clear, opaque, or solid, and may have ornamentation thereon.

The frame attached to the second edges of the two expandable side walls may be metal, bamboo, plastic, or any other material that can substantially hold its shape, and combinations thereof.

The foldable container of the aforementioned embodiments may have one or more ribbons, strings, and combinations thereof, removeably attached through the base that extend around the two expandable side walls or through the two expandable side walls. In an alternative embodiment, any of the aforementioned embodiments may have one or more ribbons, strings, and combinations thereof removeably attached through one or more holes in the base and extending outside of the two expandable side walls. These ribbons, strings, and/or combinations thereof are for purposes of decoration and/or for stabilizing the container so that they prevent the container from flipping and/or prevent the object inside the container from flipping. Extending the ribbons, strings, and combinations thereof from the base around the two expandable side walls, greatly increases the stability of the container. Stability of the container means that it does not unnecessarily rock from side to side, bend in an awkward way, or cause unwanted shifting of the object inside the container.

One or more attachment means may be attached to the top of the base within the second edges of the two expandable side walls in any of the aforementioned embodiments. The attachment means serve to secure objects within the container and prevent movement of the object when moving the inventive foldable container from place to place. The one or more attachment means may be one or more adhesive strips on the top of the base, one or more malleable tabs extending from the top of the base, one or more hook and loop fasteners; one or more strings attached to the top of the base, and combinations thereof. The one or more malleable tabs may be wire, wire covered with paper or fabric, any material that can be shaped and re-shaped, and combinations thereof. The strings may be fabric, woven material, or elastic.

One or more closure means may be attached to the second edges of the two expandable side walls. The closure means may be one or more pieces of hook and loop fasteners; one or more friction fit parts, wherein a first friction fit part on a first expandable side wall fits into a second friction fit part on a second expandable side wall; one or more magnets; and combinations thereof.

Various types of lights may be included in or on the container, placed within the container, along the second edges of the two expandable side walls, along the perimeter of the top of the base, along the perimeter of the bottom of the base, surrounding the outside of the base, on one or more attachment means, or in the two expandable side walls; for example, throughout the expandable side walls, in one or more accordion folds of the expandable side walls, or in one or more telescoping expanding components of the expandable side walls. Lights may be battery, wind-up, electric powered, or powered by other means, and may be LED-like.

In one embodiment of the invention, the container comprises a flat stable base having a top and a bottom, and a perimeter on the outside of the top, two expandable side walls, each having a first edge and a second edge, the first edge of each side wall attached to the perimeter of the top of the base, the second edge of each side wall attached to a frame having the same size and shape as one-half of the perimeter of the base, one or more closure means on the second edges of the two expandable side walls, and one or more attachment means on the top side of the base.

While the present invention has been described with regards to particular embodiments, it is recognized that additional variations of the present invention may be devised without departing from the inventive concept.

Methods of using the container are also contemplated; for example, in one embodiment, the method comprises placing an object on the top of the flat, stable base, attaching the object with one or more attachment means to the top of the base, lifting the two expandable side walls up from the base ninety degrees to meet the second edges of each of the expandable side walls together; and securing the two expandable side walls together with one or more closure means such as one or more pieces of hook and loop fasteners; one or more friction fit parts, wherein a first friction fit part on a first expandable side wall fits into a second friction fit part on a second expandable side wall; one or more magnets; and combinations thereof. The method may further comprise securing or carrying the container by one or more ribbons or strings attached through the base and extending outside of the expandable side walls, extending through the expandable side walls, and combinations thereof. The practice of the method assists in providing a secure structure to carry objects or items within a closed container. It prevents unwanted expansion or compression of the two expandable side walls and provides a flat stable container for including objects therein.

A method of using the container further comprises lighting the object or item within the container, or in providing light for an indoor or outdoor environment such as a walkway or room. The method of using the inventive container with a light may even provide a soft light for illuminating a place in need of light; for example, a dark walkway or room at night or in the early morning, or in an otherwise dark location. The method comprising placing a foldable container in a location in need of light, the foldable container having one or more lights; a flat, stable base with a top and a bottom, and a perimeter outlining the outside of the top and the bottom; two expandable side walls each of the same size, and each having a first edge and a second edge, the first edges and the second edges each having the same shape and size as one-half of the perimeter of the base, the first edge of each expandable side wall attached to one-half of the perimeter of the base, the second edge of each expandable side wall attached to a frame having the same size and shape as one-half of the perimeter of the base; one or more closure means on each of the second edges of the two expandable side walls, wherein the closure means secure the second edges of the two expandable side walls together and close the container; and one or more attachment means on the top of the base, wherein the attachment means secure the object to the top of the base; ensuring a source of power to the one or more lights so that the lights are illuminated; lifting the two expandable side walls ninety degrees (90°); and securing the two expandable side walls together by one or more attachment means. The light may be attached to the top of the base, attached to the frame, attached to the perimeter of the base inside of the container, attached to the perimeter of the base outside of the container, attached in and throughout the expandable side walls. For example, the lights may be lined in one or more pleats in the expandable side walls. Alternatively, a user may place a light in the container. The source of power to the lights may be via battery, electricity, wind-up generator, or other power providing source, and the lights may be LED lights, low-voltage lights, and candles. The lights may be string-like in that they extend around the perimeter of the outside or the inside of the container, or they extend through the expandable side walls, or frame.

The method of providing light using the foldable container may serve to light a pathway and illuminate a food or gift item in a dark venue. For example, the foldable container having a light can assist in illuminating objects and items within the container, leading the way to a festive event where guests arrive carrying the containers with festive objects therein, providing mood lighting, and providing safety lighting or night-lights in homes, hotels, theaters, stairwells, parking garages, or other dark locations in need of light.

### INDUSTRIAL APPLICABILITY

The container is useful for holding and carrying objects, including food items such as truffles, cakes, hard candy or other deserts, take-out meals, and party snacks; battery powered, electric, or other powered lights such as LED lights, low-voltage lights, and candles; cosmetic products, party favors, wedding favors, and gift items such as jewelry, clothing, trinkets, toys, accessories; miscellaneous prizes; or informational matter such as gift cards, vouchers, coupons, or event tickets. The container is also useful in providing light for the object or item within the container or for providing light in an environment in need thereof.

What is claimed is:

1. A container for an object comprising:
(a) a flat, stable base having a top and a bottom, a perimeter on the outside of the top, and one or more holes extending from the top to the bottom of the base;
(b) two expandable side walls each of the same size, and each having a first edge and a second edge, the first edges and the second edges each having the same shape and size as one-half of the perimeter of the base;
(c) the first edge of each expandable side wall attached to one-half of the perimeter of the top of the base;
(d) the second edge of each expandable side wall attached to a frame having the same size and shape as one-half of the perimeter of the base;
(e) one or more closure means on each of the second edges of the two expandable side walls, wherein the closure means secure the second edges of the two expandable side walls together, and
(f) one or more attachment means on the top of the base, wherein the attachment means secure the object to the top of the base.

2. The container of claim 1, wherein the two expandable side walls are paper.

3. The container of claim 1, wherein the two expandable side walls contain accordion pleats.

4. The container of claim 1, wherein the frame is metal.

5. The container of claim 1, wherein the frame is bamboo.

6. The container of claim 1, wherein the frame is plastic.

7. The container of claim 1, further comprising one or more ribbons attached to the base through the one or more holes and extending through the two expandable side walls.

8. The container of claim 1, further comprising one or more ribbons attached to the base through the one or more holes and extending outside of the two expandable side walls.

9. The container of claim 1, wherein the perimeter of the flat base has a substantially asymmetrical geometric shape.

10. The container of claim 9, wherein the substantially asymmetrical geometric shape is substantially square, circular, rectangular, oval, heart, diamond, hexagonal, a parallelogram, and combinations thereof.

11. The container of claim 1, wherein the attachment means on the base are one or more adhesive strips on the top of the base.

12. The container of claim 1, wherein the attachment means on the base are one or more malleable tabs extending from the top of the base.

13. The container of claim 1, wherein the attachment means on the base are one or more strings attached to the top of the base.

14. The container of claim 1, wherein the closure means on the second edges of the two expandable side walls are one or more pieces of hook and loop fasteners.

15. The container of claim 1, wherein the closure means on the second edges of the two expandable side walls are one or more friction fit parts, and wherein a first friction fit part on a first expandable side wall fits into a second friction fit part on a second expandable side wall.

16. The container of claim 1, wherein the closure means on the second edges of the two expandable side walls are one or more magnets.

17. The container of claim 1, wherein the container further comprises one or more lights within the container throughout the expandable side walls.

18. A method of using the container of claim 1 comprising:
(a) placing an object on the top of the flat, stable base,
(b) attaching the object with the one or more attachment means to the top of the base,
(c) lifting the two expandable side walls up from the base ninety degrees so that the second edges of each of the expandable side walls meet together, and
(d) securing the two expandable side walls together with one or more closure means such as one or more pieces of hook and loop fasteners; one or more friction fit parts, wherein a first friction fit part on a first expandable side wall fits into a second friction fit part on a second expandable side wall; one or more magnets; and combinations thereof.

19. The method of claim 18 further comprising securing the container by one or more ribbons or strings attached to the base and extending through the expandable side walls, one or more ribbons or strings attached to the base and extending outside of the expandable side walls, and combinations thereof.

20. The method of claim 18 further comprising carrying the container by one or more ribbons or strings attached to the base and extending through the expandable side walls, one or more ribbons or strings attached to the base and extending outside of the expandable side walls, and combinations thereof.

21. A method of providing light for an environment comprising:
(a) placing a foldable container in a location in need of light, the foldable container having one or more lights; a flat, stable base with a top and a bottom, and a perimeter outlining the outside of the top and the bottom; two expandable side walls each of the same size, and each having a first edge and a second edge, the first edges and the second edges each having the same shape and size as one-half of the perimeter of the base, the first edge of each expandable side wall attached to one-half of the perimeter of the base, the second edge of each expandable side wall attached to a frame having the same size and shape as one-half of the perimeter of the base; one or more closure means on each of the second edges of the two expandable side walls, wherein the closure means secure the second edges of the two expandable side walls together and close the container; and one or more attachment means on the top of the base, wherein the attachment means secure the object to the top of the base;
(b) ensuring a source of power to the one or more lights so that the lights are illuminated;
(c) lifting the two expandable side walls ninety degrees; and
(d) securing the two expandable side walls together by one or more attachment means.
